(19) United States
(12) Patent Application Publication
(10) Pub. No.: US 2009/0055932 A1
(43) Pub. Date: Feb. 26, 2009

(54) INFORMATION DISTRIBUTING APPARATUS AND METHOD, RECEIVING APPARATUS AND METHOD, DISTRIBUTION SYSTEM, AND COMPUTER PROGRAM

(75) Inventor: Kazuo Kuroda, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 11/814,613

(22) PCT Filed: Jan. 24, 2006
(86) PCT No.: PCT/JP2006/301008

§ 371 Date: Sep. 21, 2007

(30) Foreign Application Priority Data
Jan. 24, 2005 (JP) 2005-015964

(51) Int. Cl. H04L 9/00

(52) U.S. Cl. 726/26

(57) ABSTRACT

A distribution system is provided with: a distributing apparatus being provided with: a first compressing device (202) for compressing first data, which is a reproduction reference in a first compression method (MPEG2); a second compressing device (203) for compressing second data other than the first data in a second compression method (MPEG4); an encrypting device (205) for encrypting at least one portion of the compressed first data; and a distributing device (207) for distributing each of the encrypted first data and the compressed second data to a receiving apparatus, and a receiving apparatus being provided with: a receiving device (307) for receiving each of the encrypted first data and the compressed second data; a converting device (304) for converting the compression method for the compressed second data to the first compression method; and a generating device for generating the content data by combining the encrypted first data with the second data whose compression method is converted.

### TECHNICAL FIELD

The present invention relates to an apparatus for and a method of distributing content data, such as movies and music, an apparatus for and a method of receiving the content data to record or reproduce it, a distribution system provided with the distributing apparatus and the receiving apparatus, and a computer program which makes a computer function as the distributing apparatus, the receiving apparatus or the like, for example.

### BACKGROUND ART

A large-volume recording medium, such as a DVD, has been spread, and even at home, there is an improved environment in which movie contents or the like can be readily watched. Moreover, there has been also spread such a style that the movie contents or the like are obtained through the network and that the obtained movie contents are recorded on the DVD or the like and watched.

In this case, in order to protect the copyright of the movie contents, generally, the distributed movie contents or the like are encrypted. This encryption is performed in accordance with an encryption system disclosed in a non-patent document 1, for example. As a more specific method of distributing the movie contents or the like, as disclosed in a patent document 1 or the like, there is suggested a distribution system for recording an encryption key, which is used for an encryption process, in advance on a record-type DVD or the like, such as a DVD-R/RW, selling it, and distributing the encrypted movie contents through the network.

There are also suggested various encryption methods (or content distribution systems), as disclosed in patent documents 2 and 3. These encryption methods prevent the illegal copy of the movie contents or the like in the middle of the distribution, also leading to the protection of the copyright of the movie contents.

Patent document 1: Japanese Patent Application Laid Open NO. 2001-307427
Patent document 2: Japanese Patent Application Laid Open NO. 2001-357001
Patent document 3: Japanese Patent Application Laid Open NO. 2000-331412
Non-patent document 1: “Protection of DVD contents”, Toshiba review, Vol. 58, No. 6, p 28-p 31, 2003

### DISCLOSURE OF INVENTION

### Subject to be Solved by the Invention

In the current distribution system, however, a moving picture experts group2 (MPEG2) compression method is mainly used to compress/encode and to distribute the movie contents or the like. Thus, there is such a problem that transmitting efficiency is worse than that in a case where a MPEG4 compression method, which allows more highly efficient compression, is used to compress the movie contents or the like. On the other hand, if the MPEG4 compression method is used to compress/encode the movie contents or the like, the transmitting efficiency is better, but the contents need to be encrypted on the end-user side. Thus, there is such a problem that an environment as secure as ever is hardly maintained.

It is therefore an object of the present invention to provide an information recording medium, an information recording apparatus and method, an information distributing apparatus and method, which allow the contents or the like to be distributed while ensuring confidentiality and the improving transmitting efficiency, and a computer program which makes a computer function as the information recording apparatus and the information distributing apparatus.

### Means for Solving the Subject

(Distributing Apparatus and Method)

The above object of the present invention can be achieved by a distributing apparatus provided with: a first compressing device for compressing first data, which is a reproduction reference, out of predetermined content data in a first compression method; a second compressing device for compressing at least second data other than the first data out of the content data in a second compression method with higher compression efficiency than that of the first compression method; an encrypting device for encrypting at least one portion of the compressed first data; and a distributing device for distributing each of the encrypted first data and the compressed second data to a receiving apparatus.

According to the distributing apparatus of the present invention, the first data, which is the reproduction reference, out of the content data is compressed in the first compression method, by the operation of the first compressing device. At this time, it is only necessary to compress at least the first data in the first compression method, and all the content data may be compressed in the first compression method. Alternatively, all the content data may be compressed in the first compression method before the first data is selectively extracted. The second data, which is reproduced on the basis of the first data, is compressed in the second compression method, by the operation of the second compressing device. At this time, it is only necessary to compress at least the second data in the second compression method, and all the content data may be compressed in the second compression method. Alternatively, after that, the second data may be selectively extracted.

The “first data” herein means data which is a reference when the second data is reproduced. For example, an I picture in MPEG, which is one specific example of the compression method, corresponds to one specific example of the first data. On the other hand, the “second data” means data which cannot be reproduced solo and which can be reproduced on the basis of the first data (or with reference to the first data). For example, a B picture in MPEG corresponds to one specific example of the second data. Moreover, a P picture in MPEG corresponds to one specific example of the first data from the viewpoint that it is a reproduction reference of the B picture. On the other hand, the P picture corresponds to one specific example of the second data from the viewpoint that it is reproduced on the basis of the I picture.

After that, the first data compressed in the first compression method (or one portion thereof) is encrypted by the operation of the encrypting device. Then, the encrypted first data and the second data compressed in the second compression method (or all the content data compressed in the second compression method) are distributed to a receiving apparatus described later, by the operation of the distributing device.

The following various benefits can be received by distributing the first data compressed in the first compression method and the second data compressed in the second compression method, as described above. Firstly, it is possible to improve transmitting efficiency in the distribution. In other words, it is possible to reduce a time length required for the distribution of the content data because the second compression method is used, which allows more highly efficient compression, as compared to an aspect in which all the content data is compressed in the first compression method and distributed.

Moreover, since the first data, which is absolutely necessary for the reproduction of the content data, is encrypted and distributed, the confidentiality of the content data itself is certainly ensured. Even if the second data is obtained by a third party, the reproduction cannot be performed only by the second data itself. Thus, it is possible to ensure the confidentiality of the content data itself, certainly. Since the confidentiality of the content data itself can be ensured as long as the first data is encrypted, it is not necessary to further encrypt the second data, which is compressed in the second compression method and distributed. This further simplifies the operation of the distributing apparatus.

If all the content data is compressed in the second compression method, such as a MPEG4 compression method, and distributed, the transmitting efficiency can be simply improved. However, for example, the MPEG4 compression method is not employed as the compression method which is used in recording the content data onto a recording medium, such as a DVD. Thus, a conversion process is required for the compression method of all the content data, aside from a recording operation. Moreover, for example, the content data compressed in the MPEG4 compression method cannot be encrypted by the encryption method which is used in recording the content data onto the recording medium, such as a DVD, in terms of the standard of the MPEG4 compression method. Thus, when the content data is recorded onto the recording medium, an encryption process is required for all the content data, aside from the recording operation. The processes which are required aside from the recording operation lead to an increase in processing load, which is not preferable. According to the distributing apparatus of the present invention, however, it is not necessary to perform these processes, and this leads to a reduction in processing load, which is a great advantage. Additionally, the confidentiality of the content data itself can be ensured.

Consequently, according to the distributing apparatus of the present invention, it is possible to distribute contents while ensuring the confidentiality and improving the transmitting efficiency.

In another aspect of the distributing apparatus of the present invention, the first compression method is the same as a compression method which is used in recording the distributed content data onto a recording medium.

According to this aspect, it is not necessary to perform a special process, such as a process of converting the compression method, on a recording apparatus provided with a receiving apparatus described later, after the content data is distributed. Therefore, it is possible to simplify the recording operation of the recording apparatus or the like.

In another aspect of the distributing apparatus of the present invention, the encrypting device encrypts the compressed reference data in the same encryption method as an encryption method which is used in recording the distributed content data onto a recording medium.

According to this aspect, it is not necessary to perform a special process, such as a process of converting the encryption method, on the recording apparatus provided with a receiving apparatus described later, after the content data is distributed. Therefore, it is possible to simplify the recording operation of the recording apparatus or the like.

Moreover, since the first data, which is the reproduction reference, is encrypted in such an encryption method, the other second data or the like is not necessarily encrypted. That is, if the first data cannot be reproduced, naturally, the second data, which is reproduced on the basis of the first data, cannot be reproduced. Thus, the confidentiality of the content data can be ensured.

In another aspect of the distributing apparatus of the present invention, the second compressing device compresses all the content data, and the distributing device distributes each of the encrypted first data and the compressed content data.

According to this aspect, the second compressing device does not have to extract the second data from the content data and compress it (or does not have to selectively extract the second data after compressing all the content data). Therefore, it is possible to reduce the processing load on the distributing apparatus.

In another aspect of the distributing apparatus of the present invention, the encrypting device selectively encrypts one portion of the compressed first data.

According to this aspect, all the first data is not necessarily encrypted. Thus, it is possible to reduce the processing load on the encrypting device, relatively. If the encrypted one portion of the first data cannot be decoded, the first data cannot be reproduced. As a result, the content data cannot be reproduced. Thus, the confidentiality of all the content data is not changed, and the copyright of the content data is preferably protected.

In another aspect of the distributing apparatus of the present invention, the encrypting device encrypts the compressed second data, and the distributing device distributes the encrypted second data.

According to this aspect, the second data is also encrypted and distributed in addition to the first data. Therefore, the confidentiality of all the content data can be further improved, and the copyright of the distributed content data is preferably protected.

In another aspect of the distributing apparatus of the present invention, the content data includes motion picture data, the first compression method is MPEG (Moving Picture Experts Group) 2 and the second compression method is MPEG4, the first data includes an image (for example, an I picture in MPEG) which is at least a reference out of the motion picture data, and the second data includes an image (for example, an B picture in MPEG) other than the image which is the reference out of the motion picture data.

According to this aspect, it is possible to distribute the content data according to the MPEG, which is the standard compression method for the recording medium, such as a DVD, preferably, while receiving the above-mentioned various benefits.

The above object of the present invention can be also achieved by a distributing method provided with: a first compressing process of compressing first data, which is a reproduction reference, out of predetermined content data in a first compression method; a second compressing process of compressing at least second data other than the first data out of the content data in a second compression method with higher compression efficiency than that of the first compression method; an encrypting process of encrypting at least one portion of the compressed first data; and a distributing process of distributing each of the encrypted first data and the compressed second data to a receiving apparatus.

According to the distributing method of the present invention, it is possible to receive the various benefits of the distributing apparatus of the present invention described above.

Incidentally, in response to the above-mentioned various aspects of the distributing apparatus of the present invention, the distributing method of the present invention can also employ various aspects.

(Receiving Apparatus and Method)

The above object of the present invention can be also achieved by a receiving apparatus for receiving the content data distributed from the distributing apparatus of the present invention described above (including its various aspects), the receiving apparatus provided with: a receiving device for receiving each of the encrypted first data and the compressed second data, which are distributed; a converting device for converting the compression method for the compressed second data from the second compression method to the first compression method; and a generating device for generating the content data by combining the encrypted first data with the second data whose compression method is converted.

According to the receiving apparatus of the present invention, the distributed content data is received by the operation of the receiving device. The distributed content data includes the first data, which is encrypted and compressed in the first compression method, and the second data (or all the content data), which is compressed in the second compression method. Out of this, the second data compressed in the second compression method is converted to the second data compressed in the first compression method, by the operation of the converting device. In other words, the second data compressed in the same compression method as that for the distributed first data is generated. After that, the original content data (i.e. the content data compressed in the first compression method) is generated by the operation of the generating device, by combining the distributed first data with the converted second data.

Consequently, according to the receiving apparatus of the present invention, it is possible to preferably receive the content data distributed from the distributing apparatus of the present invention described above and to perform various processes thereon, to thereby reproduce it as the original content data or record it onto the recording medium.

In one aspect of the receiving apparatus of the present invention, it is further provided with a reproducing device for reproducing the generated content data.

According to this aspect, a user can preferably watch the distributed content data by the operation of the reproducing device.

In another aspect of the receiving apparatus of the present invention, it is further provided with a recording device for recording the generated content data onto a recording medium.

According to this aspect, it is possible to record the distributed content data onto the recording medium, preferably, by the operation of the recording device. Therefore, a user can preferably watch the distributed content data if loading the recording medium into a reproducing apparatus or the like.

In an aspect of the receiving apparatus provided with the recording device, as described above, it is further provided with an imaging device for generating image file data in conformity to a recording format of the recording medium, on the basis of the generated content data, the recording device recording the image file data onto the recording medium as the content data.

By virtue of such construction, the recording device can record the content data onto the recording medium, relatively easily, without a special data conversion process, format conversion process, or the like, as long as it records an image file generated by the operation of the imaging device.

The above object of the present invention can be also achieved by a receiving method of receiving the content data distributed from the distributing apparatus of the present invention described above (including its various aspects), the receiving method provided with: a receiving process of receiving each of the encrypted first data and the compressed second data, which are distributed; a converting process of converting the compression method for the compressed second data from the second compression method to the first compression method; and a generating process of generating the content data by combining the encrypted first data with the second data whose compression method is converted.

According to the receiving method of the present invention, it is possible to receive the various benefits of the receiving apparatus of the present invention described above.

Incidentally, in response to the above-mentioned various aspects of the receiving apparatus of the present invention, the receiving method of the present invention can also employ various aspects.

(Distribution System)

The above object of the present invention can be also achieved by a distribution system provided with: a distributing apparatus for distributing predetermined content data; and at least one receiving apparatus for receiving the distributed content data, the distributing apparatus provided with: a first compressing device for compressing first data, which is a reproduction reference, out of predetermined content data in a first compression method; a second compressing device for compressing at least second data other than the first data out of the content data in a second compression method with higher compression efficiency than that of the first compression method; an encrypting device for encrypting at least one portion of the compressed first data; and a distributing device for distributing each of the encrypted first data and the compressed second data to a receiving apparatus, the receiving apparatus provided with: a receiving device for receiving each of the encrypted first data and the compressed second data, which are distributed; a converting device for converting the compression method for the compressed second data from the second compression method to the first compression method; and a generating device for generating the content data by combining the encrypted first data with the second data whose compression method is converted.

According to the distribution system of the present invention, it is possible to distribute the content data and receive the distributed content data while receiving the same benefits as those of each of the distributing apparatus and the receiving apparatus of the present invention described above.

Incidentally, in response to the above-mentioned respective various aspects of the distributing apparatus and the receiving apparatus of the present invention, the distribution system of the present invention can also employ various aspects.

(Computer Program)

The above object of the present invention can be also achieved by a first computer program for distribution control to control a computer provided in the distributing apparatus of the present invention described above (including its various aspects), to make the computer function as at least one portion of the first compressing device, the second compressing device, the encrypting device, and the distributing device.

Moreover, the above object of the present invention can be also achieved by a second computer program for reception control to control a computer provided in the receiving apparatus of the present invention described above (including its various aspects), to make the computer function as at least one portion of the receiving device, the converting device, and the generating device.

According to each computer program of the present invention, the above-mentioned distributing apparatus or receiving apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the above-mentioned various aspects of the distributing apparatus or receiving apparatus of the present invention, each computer program of the present invention can also adopt various aspects.

The above object of the present invention can be also achieved by a first computer program product in a computer-readable medium for tangibly embodying a program of instructions executable by a computer provided in the above-mentioned distributing apparatus of the present invention (including its various aspects), to make the computer function as at least one portion of the first compressing device, the second compressing device, the encrypting device, and the distributing device. The above object of the present invention can be also achieved by a second computer program product in a computer-readable medium for tangibly embodying a program of instructions executable by a computer provided in the above-mentioned receiving apparatus of the present invention (including its various aspects), to make the computer function as at least one portion of the receiving device, the converting device, and the generating device.

According to each computer program product of the present invention, the above-mentioned distributing apparatus or receiving apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the above-mentioned distributing apparatus or receiving apparatus of the present invention.

These effects and other advantages of the present invention will become more apparent from the following embodiments.

As explained above, the distributing apparatus of the present invention is provided with the first compressing device, the second compressing device, the encrypting device, and the distributing device. The distributing method of the present invention is provided with the first compressing process, the second compressing process, the encrypting process, and the distributing process. Therefore, it is possible to distribute contents while ensuring the confidentiality and improving the transmitting efficiency.

Moreover, the receiving apparatus of the present invention is provided with the receiving device, the converting device, and the generating device. The receiving method of the present invention is provided with the receiving process, the converting process, and the generating process. Therefore, it is possible to receive the content data distributed by the distributing apparatus of the present invention, preferably, and then reproduce it or record it onto a recording medium.

### BRIEF DESCRIPTION OF DRAWINGS

FIG. 1 is a block diagram conceptually showing the basic structure of an embodiment according to the distribution system of the present invention.

FIG. 2 is a block diagram conceptually showing the basic structure of a content distributing server (i.e. an embodiment according to the distributing apparatus of the present invention) provided for the distribution system in the embodiment.

FIG. 3 is a block diagram conceptually showing the basic structure of an information recording/reproducing apparatus (i.e. an embodiment according to the receiving apparatus of the present invention) provided for the distribution system in the embodiment.

FIG. 4 is a sequence diagram conceptually showing all the operations of the distribution system in the embodiment.

FIG. 5 is a flowchart conceptually showing a flow of the operations of the content distributing server in the embodiment.

FIG. 6 is a data structure diagram showing a series of data units including each picture of content data defined by a MPEG2 compression method or MPEG4 compression method.

FIG. 7 are data structure diagrams showing content data after it is MPEG2-compressed by the content distributing server in the embodiment and an I picture and P pictures are extracted, and content data after it is MPEG4-compressed.

FIG. 8 is a flowchart conceptually showing a flow of the operations associated with the encryption of the content data.

FIG. 9 is a data structure diagram conceptually showing the data structure of encrypted contents.

FIG. 10 is a flowchart conceptually showing a flow of the operations of the information recording/reproducing apparatus in the embodiment.

FIG. 11 are data structure diagrams showing content data after predetermined pictures are extracted out of the MPEG2-compressed content data, and content data after predetermined pictures are extracted out of the MPEG4-compressed content data.

FIG. 12 are data structure diagrams conceptually showing an embodiment in which one portion of each of the I picture and the P picture is selectively encrypted.

### DESCRIPTION OF REFERENCE CODES

100 optical disc
200 content distributing server
202 MPEG2 compressor
203 MPEG4 compressor
204 picture extractor
205 encryption device
206 multiplexer
207 external interface
251 CPU
300 information recording/reproducing apparatus
301 signal recording/reproducing device
302 image-filing device
303 multiplexer
304 MPEG2 convertor
305 MPEG4 decompressor
306 demultiplexer
307 external interface
351 CPU

### BEST MODE FOR CARRYING OUT THE INVENTION

Hereinafter, the best mode for carrying out the present invention will be explained in each embodiment in order with reference to the drawings.

(1) Basic Structure

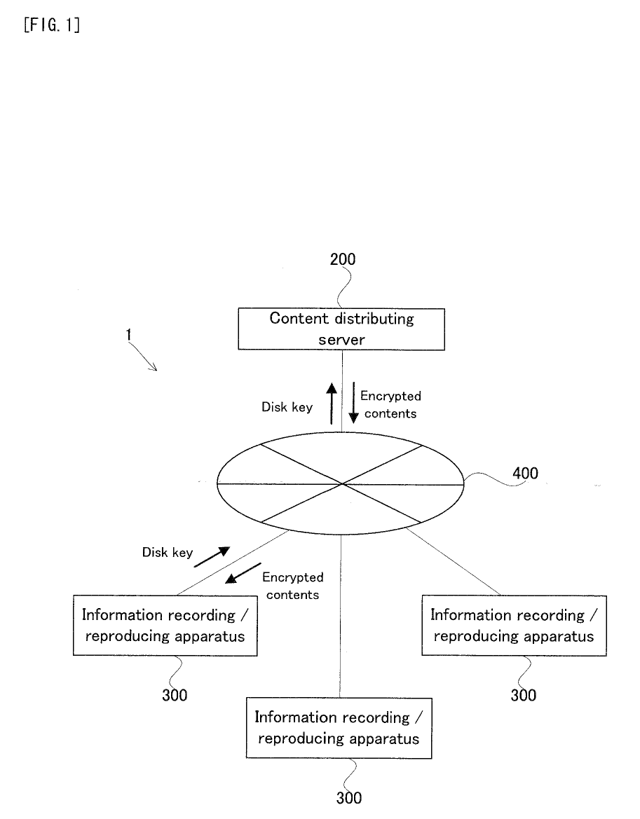

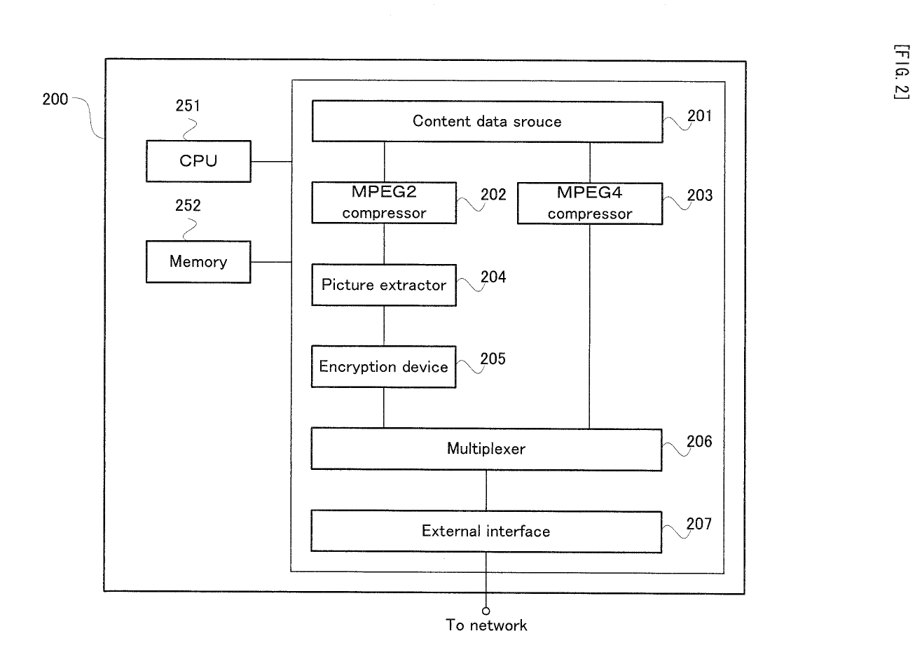

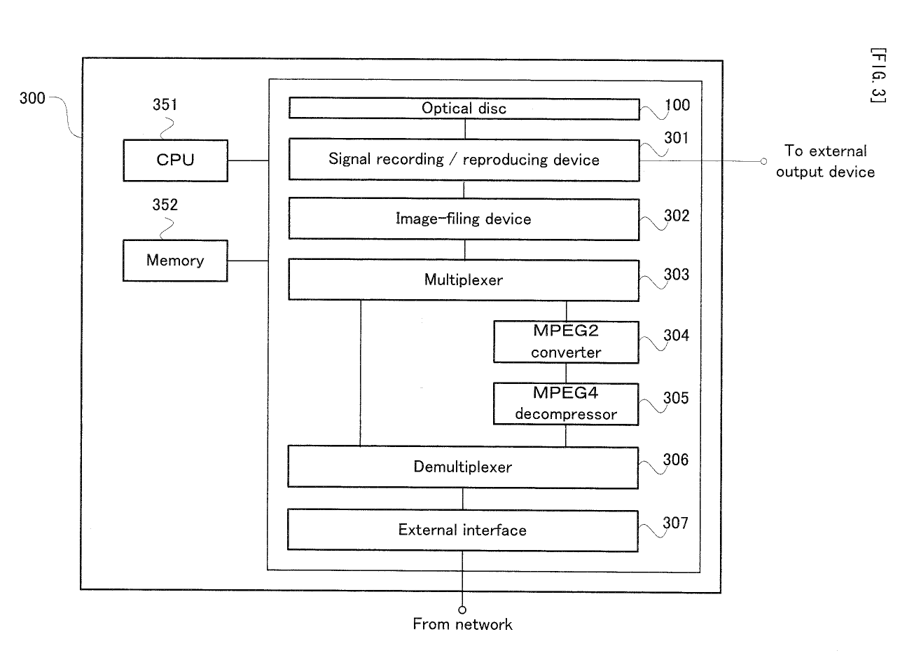

Firstly, with reference to FIG. 1 to FIG. 3, an explanation will be given for the basic structure of a content distribution system (i.e. a content distribution system provided with respective embodiments of the distributing apparatus and the receiving apparatus of the present invention), as an embodiment of the distribution system of the present invention. FIG. 1 is a block diagram conceptually showing the basic structure of an embodiment according to the distribution system of the present invention. FIG. 2 is a block diagram conceptually showing the basic structure of a content distributing server (i.e. an embodiment according to the distributing apparatus of the present invention) provided for the distribution system in the embodiment. FIG. 3 is a block diagram conceptually showing the basic structure of an information recording/reproducing apparatus (i.e. an embodiment according to the receiving apparatus of the present invention) provided for the distribution system in the embodiment.

As shown in FIG. 1, a content distribution system 1 is configured by connecting a content distributing server 200 and a plurality of information recording/reproducing apparatuses 300 through a network 400. From the information recording/reproducing apparatuses 300, a disk key necessary for the encryption of content data is transmitted to the content distributing server 200 through the network 400. From the content distributing server 200, the content data encrypted by using the disk key is distributed to the information recording/reproducing apparatuses 300 through the network 400.

As shown in FIG. 2, the content distributing server 200 is provided with: a content data source 201; a MPEG2 compressor 202, which constitutes one specific example of the “first compressing device” of the present invention; a MPEG4 compressor 203, which constitutes one specific example of the “second compressing device” of the present invention; a picture extractor 204; an encryption device 205, which constitutes one specific example of the “encrypting device” of the present invention; a multiplexer 206; an external interface 207, which constitutes one specific example of the “distributing device” of the present invention; a CPU 251; and a memory 252.

The content data source 201 stores therein various content data (e.g. video contents, such as movies and TV programs, music contents and the like), which are distributed to the information recording/reproducing apparatus 300. The content data source 201 is adapted to output the stored various content data to the MPEG2 compressor 202 and the MPEG4 compressor 203. Alternatively, the content data source 201 may be adapted to receive programs or shows, which are broadcasted through networks or through ground waves or satellite waves, and to output the received programs (i.e. the various contents) to the MPEG2 compressor 202 and the MPEG4 compressor 203.

The MPEG2 compressor 202 performs MPEG2 compression on the content data outputted from the content data source 201. The MPEG2 compressor 202 is adapted to output the MPEG2-compressed content data to the picture extractor 204.

The MPEG4 compressor 203 performs MPEG4-AVC (Advanced Video Coding) compression (hereinafter referred to as “MPEG4 compression”), which is more highly efficient than the MPEG2 compression, on the content data outputted from the content data source 201. The MPEG4 compressor 203 is adapted to output the MPEG4-compressed content data to the multiplexer 206.

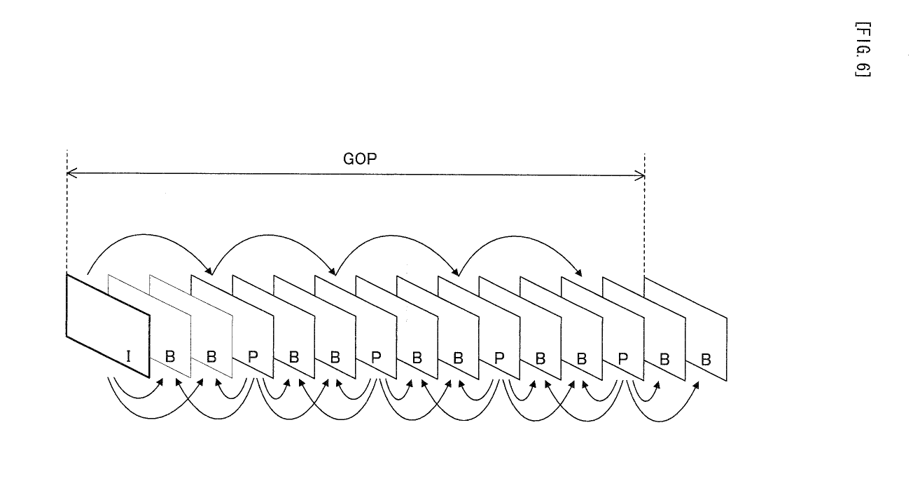

The picture extractor 204 is adapted to extract an I picture (Intra-coded Picture), which constitutes one specific example of the “first data” of the present invention, from the MPEG2-compressed content data. Moreover, the picture extractor 204 may be adapted to extract a P picture (Predictive-coded Picture), which constitutes one specific example of the “first data” of the present invention. The picture extractor 204 is adapted to output the extracted I picture (and further, P picture) to the encryption device 205. Incidentally, the MPEG2 compression method (or MPEG4 compression method) will be detailed later (refer to FIG. 6).

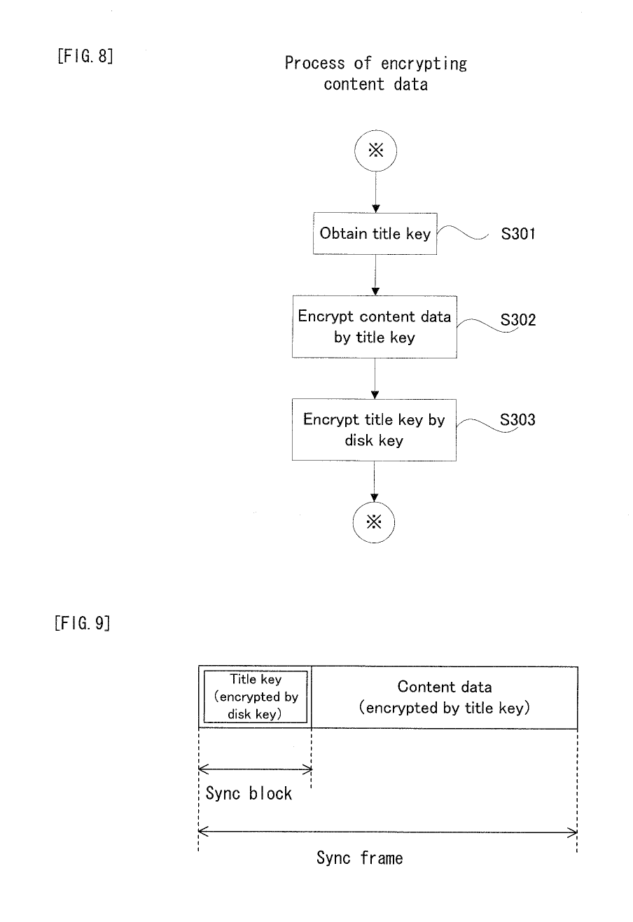

The encryption device 205 encrypts the various content data outputted from the content data source 201 by using the disk key transmitted from the information recording/reproducing apparatus 300. In the embodiment, particularly, the encryption device 205 encrypts the I picture (and further, P picture) outputted from the picture extractor 204. The encryption process will be detailed later (refer to FIGS. 8 and 9).

The multiplexer 206 is adapted to combine the I picture (and further, P picture) outputted from the encryption device 205 with the content data outputted from the MPEG4 compressor 203, to thereby generate the combined content data. Moreover, the multiplexer 206 is adapted to output the combined content data to the external interface 207.

The external interface 207 is adapted to output (or distribute) the data from the content distributing server 200 to the exterior, or to obtain (or receive) the data inputted (or transmitted) from the exterior. For example, the external interface 207 is adapted to receive the disk key transmitted from the information recording/reproducing apparatus 300, or to distribute (or transmit) the combined content data to the information recording/reproducing apparatus 300. In particular, the received disk key is outputted to the encryption device 205 and is used for the encryption of the content data.

The CPU 251 is connected through a not-illustrated bus with the content data source 201, the MPEG2 compressor 202, the MPEG4 compressor 203, the picture extractor 204, the encryption device 205, the multiplexer 206, the external interface 207, the memory 252 and the like, to thereby control the operation of the entire content distributing server 200. Normally, software for operating the CPU 251 is stored in the memory 252.

The memory 252 is provided with a buffer area for the content data, an area used as an intermediate buffer when the format of the content data or the like is converted, and the like. The memory 252 is used in the general data processing on the content distributing server 200. Moreover, the memory 252 is provided with: a ROM area into which a program for performing an operation as the content distributing server 200 is stored; a buffer used in the general data processing performed on the content data; a RAM area into which a parameter or variable required for the operation of the program or the like is stored; and the like.

As shown in FIG. 3, the information recording/reproducing apparatus 300 is provided with: an optical disc 100, which constitutes one specific example of the “recording medium” of the present invention; a signal recording/reproducing device 301, which constitutes one specific example of the “recording device” and the “reproducing device” of the present invention; an image-filing device 302, which constitutes one specific example of the “imaging device” of the present invention; a multiplexer 303, which constitutes one specific example of the “generating device” of the present invention; a MPEG2 converter 304, which constitutes one specific example of the “converting device” of the present invention; a MPEG4 decompressor 305; a demultiplexer 306; an external interface 307, which constitutes one specific example of the “receiving device” of the present invention; a CPU 351; and a memory 352.

The optical disc 100 has a disc shape with a diameter of 12 cm, as in a DVD. The optical disc 100 is adapted to record data onto its recording surface a plurality of times or only once in various recording methods, such as a magneto-optical method and a phase change method. The optical disc 100 has the disk key recorded in advance. Information or the like (e.g. media ID) corresponding to the disk key is recorded in a Narrow Burst Cutting Area (NBCA). On the optical disc 100 various data can be recorded, or the data recorded on the optical disc 100 can be reproduced, by loading it into a not-illustrated disc drive provided for the information recording/reproducing apparatus 300.

The signal recording/reproducing device 301 records data onto the optical disc 100 or reproduces the data recorded on the optical disc 100. For example, the optical disc 100 is irradiated with laser light in a predetermined pulse shape with a predetermined power, which is emitted from a not-illustrated optical pickup provided for the information recording/reproducing apparatus 300. By this, the signal recording/reproducing device 301 records data onto the optical disc 100. Moreover, the signal recording/reproducing device 301 obtains a reproduction signal (e.g. RF signal) from reflected light obtained by irradiating the optical disc 100 with the laser light emitted from the not-illustrated optical pickup, to thereby reproduce the data. The reproduced data is outputted to an external output device including various displays, various speakers, and the like. A user can browse and watch it.

The image-filing device 302 is adapted to convert the content data outputted from the multiplexer 303 to image data in a format which can be recorded onto the optical disc 100 as it is.

The multiplexer 303 combines the MPEG2-compressed and encrypted I picture or the like, which is outputted from the demultiplexer 306, with a B picture converted into the MPEG2 compression format, which is outputted from the MPEG2 convertor 304, to thereby generate the MPEG2-compressed and encrypted content data. The multiplexer 303 is adapted to output the generated content data to the image-filing device 302.

The MPEG2 converter 304 is adapted to convert the MPEG4-compressed content data into the MPEG2 compression method. That is, the MPEG2 converter 304 is adapted to convert the MPEG4-compressed content data to the MPEG2-compressed content data. The content data converted into the MPEG2 compression format is outputted to the demultiplexer 306.

In the embodiment, particularly, the MPEG2 converter 304 is preferably adapted to convert the B picture (Bidirectionally predictive-coded Picture) or the like selectively into the MPEG2 compression format, except the I picture which is MPEG2-compressed, encrypted, and distributed by the content distributing server 200.

The MPEG4 decompressor 305 is adapted to decompress the MPEG4-compressed content data outputted from the demultiplexer 306.

The demultiplexer 306 is adapted to separate the MPEG2-compressed and encrypted I picture (and further, P picture) and the MPEG4-compressed content data. The demultiplexer 306 is adapted to output the MPEG2-compressed and encrypted I picture (and further, P picture) to the multiplexer 303, and to output the MPEG4-compressed content data to the MPEG4 decompressor 305.

The external interface 307 is adapted to output (or distribute) the data from the information recording/reproducing apparatus 300 to the exterior, or to obtain (or receive) the data inputted (or transmitted) from the exterior. For example, the external interface 207 is adapted to transmit the disk key to the content distributing server 200 or to receive the content data distributed from the content distributing server 200. In particular, the received content data is outputted to the demultiplexer 306.

The CPU 251 is connected through a not-illustrated bus with the signal recording/reproducing device 301, the image-filing device 302, the multiplexer 303, the MPEG2 convertor 304, the MPEG4 decompressor 305, the demultiplexer 306, the external interface 307, the memory 352 and the like, to thereby control the operation of the entire information recording/reproducing apparatus 300. Normally, software for operating the CPU 351 is stored in the memory 352.

The memory 352 is provided with a buffer area for the content data, an area used as an intermediate buffer when the format of the content data or the like is converted, and the like. The memory 352 is used in the general data processing on the information recording/reproducing apparatus 300. Moreover, the memory 352 is provided with: a ROM area into which a program for performing an operation as the information recording/reproducing apparatus 300 is stored; a buffer used in the general data processing performed on the content data; a RAM area into which a parameter or variable required for the operation of the program or the like is stored; and the like.

Moreover, the information recording/reproducing apparatus 300 may be provided with an operation device for receiving an operation instruction given to the information recording/reproducing apparatus 300 from a user (e.g. an operation button, an operation panel, a keyboard, a mouse, and the like).

The network 400 may employ any of wired and wireless forms. One portion of the network 400 may be wired, and another portion thereof may be wireless. Moreover, it may be a leased line, a public line, a phone line, a packet network, a line switching network, or the like. Moreover, the Internet may be employed as the external network 400. In any forms, the network line capable of transmitting and receiving the data between the information recording/reproducing apparatus 300 and the content distributing server 200 may be employed as the external network 400 in the embodiment.

(2) Explanation of Operation

Next, the operation principle of the distribution system 1 in the embodiment will be discussed.

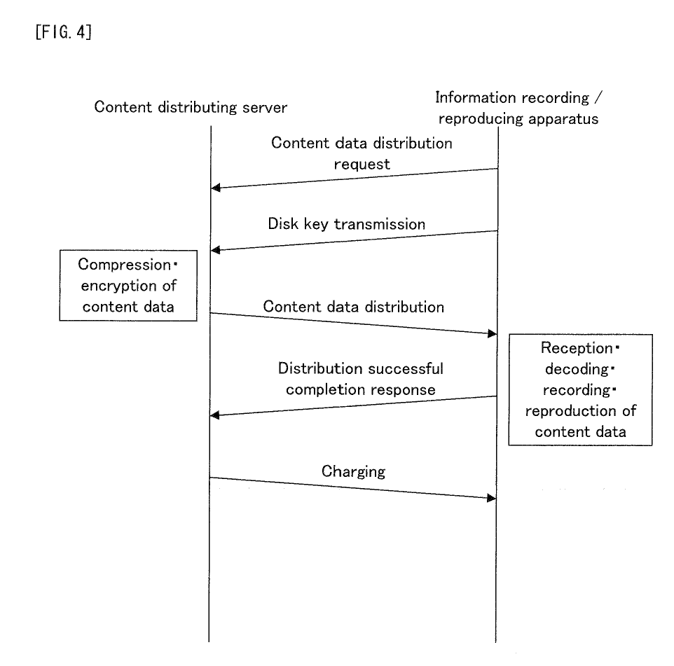

Firstly with reference to FIG. 4, an aspect of the operation of the distribution system 1 in the embodiment will be outlined. FIG. 4 is a sequence diagram conceptually showing the entire operations of the distribution system 1 in the embodiment.

As shown in FIG. 4, as the premise that the content data is distributed from the content distributing server 200 to the information recording/reproducing apparatus 300, a content distribution request instruction is outputted from the information recording/reproducing apparatus 300 to the content distributing server 200. The content distribution request instruction includes the title name of the content data whose distribution is desired, or the like.

Simultaneously with or after the transmission of the content distribution request instruction, the information recording/reproducing apparatus 300 transmits the disk key, which is used for the encryption of the content data, to the content distributing server 200. At this time, the disk key may be directly transmitted to the content distributing server 200; however, in order to prevent that the disk key is obtained by a third party illegally, the disk key is preferably encrypted in accordance with various encryption methods, such as SSL (Secure Socket Layer), and then transmitted to the content distributing server 200. Alternatively, the media ID or the like recorded in the NBCA (Narrow Burst Cutting Area) provided for the optical disc 100 may be transmitted to the content distributing server 200, and the desired disk key may be specified by using the media ID on the content distributing server 200.

After that, the content data is compressed, encrypted, or the like on the content distributing server 200 side, and the content data is distributed to the information recording/reproducing apparatus 300. The distributed content data is received by the information recording/reproducing apparatus 300. After various processes, such as a decoding process, as described later, the content data is recorded onto the optical disc 100 or reproduced.

If the distributed content data is correctly received on the information recording/reproducing apparatus 300 side (e.g. if the recording of the content data can be completed on the optical disc 100, or if the content data can be correctly watched), a distribution successful completion response is transmitted from the information recording/reproducing apparatus 300 to the content distributing server 200.

At the time point when the distribution successful completion response is received by the content distributing server 200, a charging process about the distributed content data is performed, and a user of the information recording/reproducing apparatus 300 is notified of that. In order to perform such a charging process, it is preferable for the content distributing server 200 to request the transmission of a credit card number or the like of a user who desires the distribution of the content data in the transmission of the content distribution request instruction.

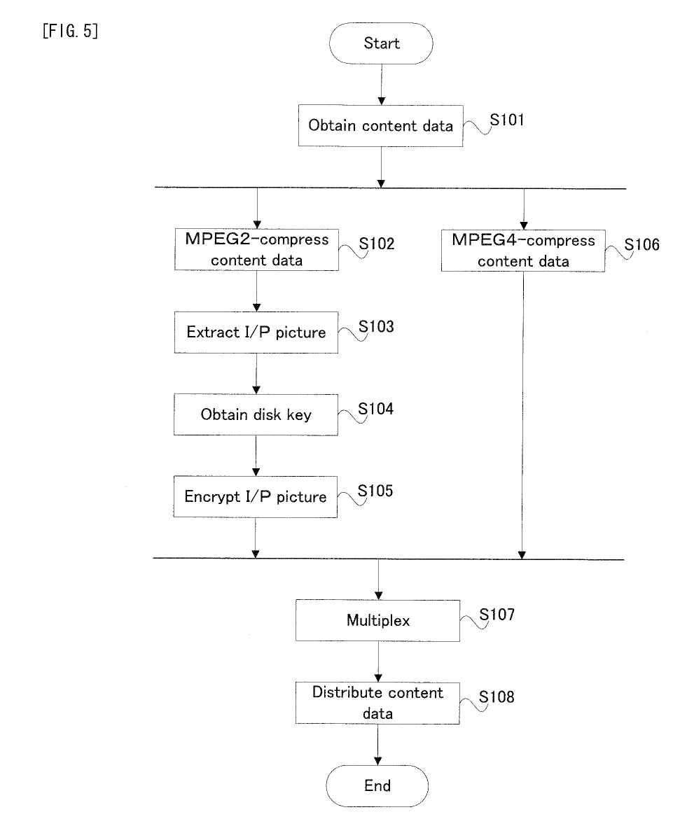

Next, the operations of each of the apparatuses (the content distributing server 200 and the information recording/reproducing apparatus 300) will be explained, individually. Firstly, with reference to FIG. 5, the operations on the content distributing server 200 side will be explained. FIG. 5 is a flowchart conceptually showing a flow of the operations of the content distributing server 200 in the embodiment.

As shown in FIG. 5, on the content distributing server 200 side, firstly, the content data is obtained under the control of the CPU 251 (step S101). Specifically, the content data whose distribution is desired by a user is obtained from the content data source 201 on the basis of the content distribution request instruction transmitted from the information recording/reproducing apparatus 300.

Then, the obtained content data is MPEG2-compressed by the operation of the MPEG2 compressor 202 (step S102). Then, the I picture and the P picture are selectively extracted from among the I picture, P picture, and B picture included in the MPEG2-compressed content data, by the operation of the picture extractor 204 (step S103). Then, the disk key is obtained (step S104). Then, encryption is performed by the operation of the encryption device 205 with respect to the I picture and P picture extracted in the step S103, by using the same encryption method as that used for the optical disc 100, which is a recording target of the information recording/reproducing apparatus 300 (step S105). The specific encryption method will be detailed later (refer to FIG. 8 and FIG. 9). Then, the encrypted I picture and P picture are outputted to the multiplexer 206.

On the other hand, the content data obtained from the content data source 201 is also MPEG4-compressed (step S106). That is, each of the MPEG2-compressed content data and the MPEG4-compressed content data is generated inside the content distributing server 200. Then, the MPEG4-compressed content data is outputted to the multiplexer 206.

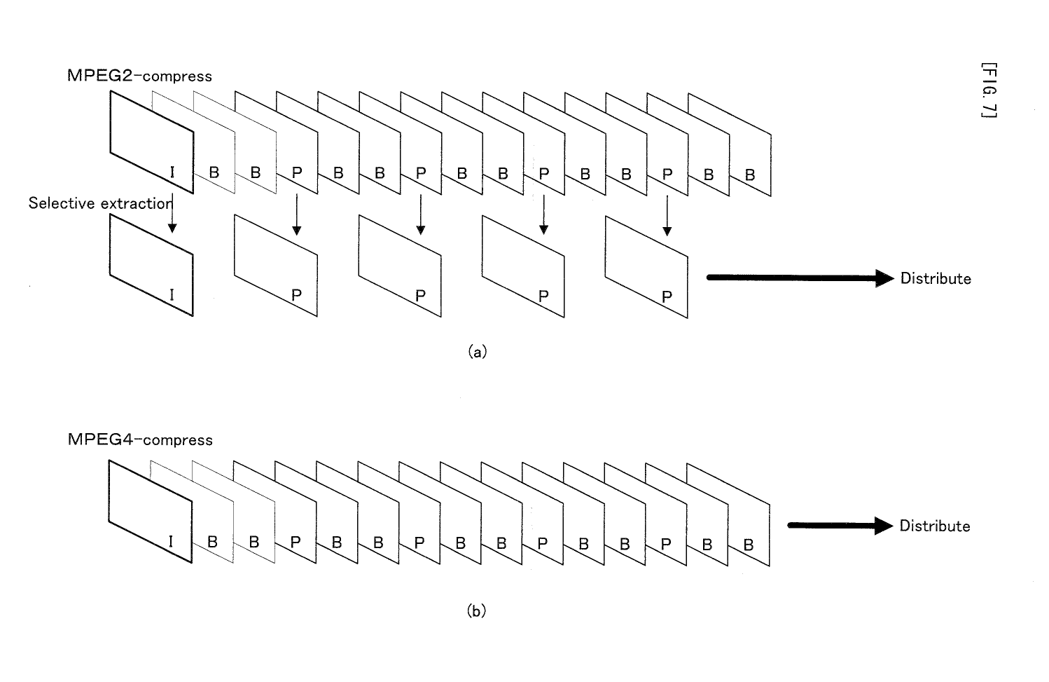

Now, the MPEG2-compressed or MPEG4-compressed content data will be explained with reference to FIG. 6 and FIG. 7. FIG. 6 is a data structure diagram showing a series of data units including each picture of the content data defined by the MPEG2 compression method or MPEG4 compression method. FIG. 7 are data structure diagrams showing the content data after it is MPEG2-compressed by the content distributing server 200 in the embodiment and an I picture and P pictures are extracted, and the content data after it is MPEG4-compressed.

The outline of the MPEG2 compression method or MPEG4 compression method will be explained. In most cases, generally, frame images existing before and after one frame image are similar to each other and have a correlation in continuous frame images. The MPEG2 compression method or MPEG4 compression method focuses this point. The MPEG2 compression method or MPEG 4 compression method generates another frame image existing among a plurality of frames by interpolating based on a motion vector or the like of an original image, on the basis of the plurality of frame images transmitted over several frames. In this case, it is only necessary to record information about a motion vector and a difference between the plurality of frame images and the another frame image, if the another frame is recorded. Upon the reproduction, the another frame image can be reproduced by being predicted from the above-mentioned plurality of frame images with reference to the motion vector and the difference. By this, video images can be compressed and recorded.

That is, as shown in FIG. 6, the MPEG2-compressed or MPEG4-compressed content data includes: a frame image represented by a code “I” (i.e. I picture); a frame image represented by a code “P” (i.e. P picture); and a frame image represented by a code “B” (i.e. B picture). The I picture is a flame image which can reproduce a complete frame image by itself. The P picture is a predicted image generated by decoding a difference between a predicted image which is compensated and reproduced on the basis of another decoded P picture or the decoded I picture and itself. The B picture is a predicted image reproduced by using not only the already-decoded I picture or P picture but also the I picture or P picture in the future time, which are recorded on the optical disc 100 or the like, for the prediction. In FIG. 6, a predictive relationship (or complementary relationship) between the pictures is shown by an arrow. Moreover, when it is actually displayed as the image, one frame image is formed by each of the pictures shown in FIG. 6.

Moreover, a group of picture (GOP), which is the smallest image unit determined in the standard of the MPEG2 compression method or MPEG4 compression method and capable of being reproduced solo, is provided with a plurality of these pictures. In the embodiment, one GOP is composed of 15 pictures; however, the number of the pictures which constitute one GOP can be arbitrarily determined in the MPEG2 compression method or MPEG4 compression method.

Incidentally, the MPEG4 compression method allows more highly efficient encoding than the MPEG2 compression method because it realizes various functions, such as 8×8 block motion-compensating function, direct prediction function, and AC/DC prediction function. In other words, the MPEG4 compression method has a higher compression ratio than the MPEG2 compression method with respect to the same content data. In addition, error resistance capability of the MPEG4 compression method is enhanced more than that of the MPEG2 compression method, and handling of multimedia is more advanced. On the other hand, the MPEG2 compression method allows the reproduction of higher-quality contents than the MPEG4 compression method. That is why the MPEG2 compression method is spread as a standard method when the content data is recorded onto a DVD or the like, which is one specific example of the optical disc 100.

Moreover, the MPEG2 compression method or MPEG4 compression method used in the embodiment employs a variable rate method in which the amount of data included in each GOP is not constant. In other words, if each picture included in one GOP corresponds to a quick motion picture and the correlation between the pictures is small, the amount of data to constitute each picture is increased, and thus the amount of data included in one GOP is also increased. On the other hand, if each picture included in one GOP corresponds to a motionless motion picture and the correlation between the pictures is large, the amount of data to constitute each picture is reduced, and thus the amount of data included in one GOP is also reduced.

The picture extractor 204 selectively extracts the I picture and the P picture from the content data MPEG2-compressed in this manner, as shown in FIG. 7(a). Then, the extracted I picture and P picture are encrypted and distributed to the information recording/reproducing apparatus 300. On the other hand, the MPEG4 compression is also performed with respect to the content data, and the MPEG4-compressed content data is distributed to the information recording/reproducing apparatus 300 with the extracted I picture and P picture.

The encryption in the step S105 in FIG. 5 will be explained with reference to FIG. 8 and FIG. 9. FIG. 8 is a flowchart conceptually showing a flow of the operations associated with the encryption of the content data. FIG. 9 is a data structure diagram conceptually showing the data structure of encrypted contents.

As shown in FIG. 8, the encryption device 205 firstly obtains a title key (step S301). The title key can be arbitrarily set in accordance with the standard, by an owner of the copyright (or a distributor, etc.) of the contents which are expected to be recorded (i.e. which are expected to be distributed). Therefore, the encryption device 205 obtains the set title key. Alternatively, if the title key is set on the content distributing server 200 side, the encryption device 205 obtains the title key by setting the title key in accordance with the standard.

Then, by the operation of the encryption device 205, the content data (specifically, the I picture and the P picture extracted from the MPEG2-compressed content data, with the sector unit of recording media being as the smallest encryption unit) is encrypted by using the title key obtained in the step S301 (step S302). Moreover, the title key used for the encryption of the contents is encrypted by using the disk key (step S303). The disk key may be directly transmitted from the information recording/reproducing apparatus 300 or may be obtained by identifying it on the basis of the associated media ID or the like. Incidentally, the disk key is not directly used for the encryption of the content data itself, but it is used for the encryption of the title key, which is used for the encryption of the content data. Thus, it can be said that the disk key is a key used for the encryption of the contents, practically.

At this time, the encrypted content data actually generated includes the encrypted title key in a sync block (i.e. a header portion) of a sync frame and includes the encrypted content data in a main body portion (i.e. a payload portion) of the sync frame, as shown in FIG. 9. Alternatively, the title key may be also recorded in the header portion of a sector, which is provided with a plurality of sync frames. The encrypted content data having such a sync frame structure is generated in the encryption process and is recorded onto the optical disc 100 by the information recording/reproducing apparatus 300, as explained below.

In FIG. 5 again, (1) the MPEG2-compressed and encrypted I picture and P picture and (2) the MPEG4-compressed content data, which are outputted to the multiplexer 206, are combined by the operation of the multiplexer 206 (step S107). Then, it is distributed, as the content data, to the information recording/reproducing apparatus 300 through the external interface 207 (step S108). In the distribution, there is a possibility that the MPEG4-compressed content data is browsed and obtained by a third party, and thus the content data is illegally obtained or reproduced. Therefore, the distributed content data (i.e. the data obtained by combining the MPEG2-compressed and encrypted I picture and P picture with the MPEG4-compressed content data) may be further encrypted in conformity to the standard of Triple DES (Triple Data Encryption Standard), SSL, or the like, and then distributed to the information recording/reproducing apparatus 300.

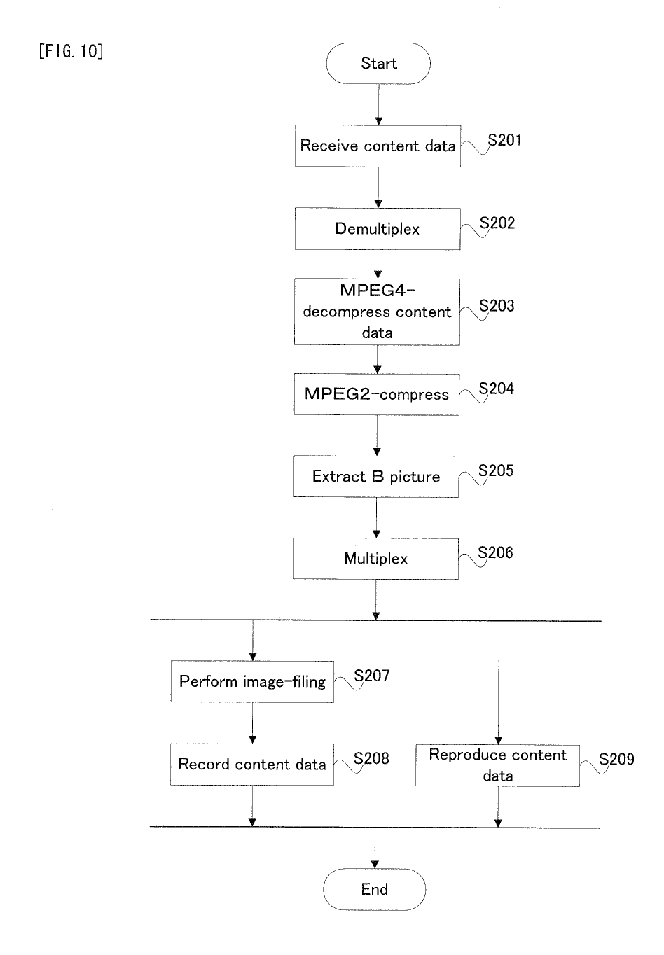

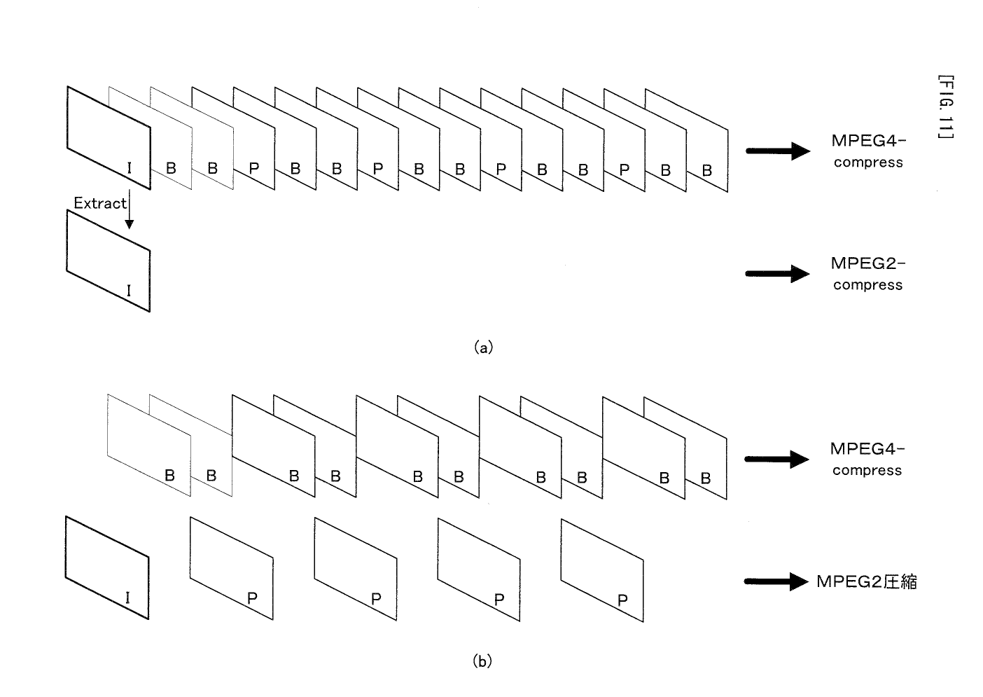

Next, with reference to FIG. 10, an explanation will be given for the information recording/reproducing apparatus 300 to which the content data is distributed. FIG. 10 is a flowchart conceptually showing a flow of the operations of the information recording/reproducing apparatus 300 in the embodiment.

As shown in FIG. 10, the distributed content data is received through the external interface 307 on the information recording/reproducing apparatus 300 side (step S201). Then, the received content data is outputted to the demultiplexer 306, and it is demultiplexed (or separated) into the MPEG2-compressed and encrypted I picture and P picture and the MPEG4-compressed content data (step S202). The MPEG2-compressed and encrypted I picture and P picture are outputted to the multiplexer 303, and the MPEG4-compressed content data is outputted to the MPEG4 decompressor 305.

On the MPEG4 decompressor 305, the MPEG4-compressed content data is decompressed (i.e. decoded) under the control of the CPU 351 (step S203). The decompressed content data is outputted to the MPEG2 convertor. Then, the content data is MPEG2-compressed (step S204). In other words, by this series of operations, the MPEG4-compressed content data is re-encoded into the MPEG2 compression method.

Then, the B picture is selectively extracted from the I picture, the P picture, and the B picture included in the content data which is MPEG2-compressed on the MPEG2 convertor 304, and it is outputted to the multiplexer 303 (step S206). That is, the B picture, which is not distributed in the MPEG2-compressed and encrypted state by the content distributing server 200, is selectively extracted and outputted to the multiplexer 303.

Then, on the multiplexer 303, the MPEG2-compressed and encrypted I picture and P picture, which are demultiplexed in the step S202, and the MPEG2-compressed B picture, which is extracted in the step S205, are multiplexed (or combined) (step S206). By this, the MPEG2-compressed content data is generated. The generated content data is outputted to the image-filing device 302 and the signal recording/reproducing device 301.

Then, the generated content data may be reproduced by the operation of the signal recording/reproducing device 301 (step S209).

Alternatively, the image filing of the content data may be performed by the operation of the image-filing device 302 (step S207), and it may be recorded onto the optical disc 100 (step S208). Specifically, on the image-filing device 302, an image file, which can be recorded onto the optical disc 100 as it is, is generated from the content data outputted from the multiplexer 303. In other words, file system information or the like for defying the recording, reproduction or the like of the content data is generated, and an image file is generated including the file system information, sector header information, content data, and the like. After that, modulation according to a DVD format, 8-16 modulation, or the like is performed with respect to the image file or the like. By this, the content data is recorded onto the optical disc 100. Moreover, instead of generating the image file, RAW data may be generated wherein the RAW data is data after the DVD modulation, namely data after ECC is appended, interleaving and scrambling are performed, and 8-16 modulation is performed thereon. The generation of the RAW data allows the data to be recorded onto the optical disc 100 as it is.

Incidentally, if the encrypted content data is not properly recorded onto the optical disc 100, the encrypted content data cannot be decoded by using the disk key. Thus, in the distribution of the encrypted content data, the attribute of the encrypted content data (i.e. CCI (Copy Control Information)) may be set to a “Never Copy” attribute. In other words, even if the encrypted content data is recorded once on a hard disk or the like before it is recorded on the optical disc 100, the encrypted content data cannot be reproduced because the disk key cannot be obtained from the hard disk. Thus, setting the attribute to the “Copy Never” attribute and distributing the content data do not cause a problem.

Then, if the recording of the distributed content data onto the optical disc 100 is correctly ended (or the reception of the distributed content data is correctly ended), the distribution successful completion response, which indicates the correct end, is transmitted to the content distributing server 200 and the operation is ended. On the content distributing server 200, which receives the distribution successful completion response for indicating the correct end, a credit card payment process may be performed, and a user may be charged actually.

As explained above, the following various benefits can be received by distributing the MPEG2-compressed I picture and P picture and the MPEG4-compressed content data. Firstly, it is possible to improve the transmitting efficiency in the distribution. In other words, as compared to the aspect in which all the content data is MPEG2-compressed and distributed, it is possible to reduce a time length required for the distribution of the content data because the MPEG4 compression method is used, which allows more highly efficient compression. At this time, the I picture and P picture are MPEG2-compressed and distributed. The total number of the I pictures and the P pictures is less than that of the B pictures. Thus, the transmitting efficiency can be improved by MPEG2-compressing and distributing each picture except the B picture.

Since the I picture, which is absolutely necessary for the reproduction as the content data, is encrypted and distributed, the confidentiality of the content data itself is certainly ensured. Even if the P picture and the B picture other than the I picture are obtained by a third party, the reproduction cannot be performed only by the P picture itself or the B picture itself. Thus, it is possible to ensure the confidentiality of the content data itself, certainly. Since the confidentiality of the content data itself can be ensured as long as the I picture is encrypted, it is not necessary to further encrypt the MPEG4-compressed and distributed B picture and record it onto the optical disc 100. Alternatively, it is not necessary to encrypt and distribute the MPEG4-compressed B picture. This further simplifies the encrypting operation of the content distributing server 200 and the recording operation or the like of the information recording/reproducing apparatus 300.

Moreover, the encryption method used for the encryption of the I picture and the P picture on the content distributing server 200 side is the same as that used when the content data is recorded onto the optical disc 100 on the information recording/reproducing apparatus 300. Thus, it is not necessary to re-encrypt the content data distributed on the information recording/reproducing apparatus 300 side (i.e. to encrypt it in accordance with the encryption method used when the content data is recorded onto the optical disc 100), and thus the recording operation can be simplified more. In addition, it is not necessary to perform a special process related to the encryption. Thus, recording compatibility or reproduction compatibility of the content data can be secured.

Moreover, the MPEG2 compression method used for the compression of the I picture and the P picture on the content distributing server 200 side is the same as the compression method used when the content data is recorded onto the optical disc 100 on the information recording/reproducing apparatus 300. Thus, it is not necessary to re-compress the content data distributed on the information recording/reproducing apparatus 300 side (i.e. to compress the content data which is compressed in another compression method, in accordance with the MPEG2 compression method), and thus the recording operation can be simplified more.

If all the content data is MPEG4-compressed and distributed, the transmitting efficiency can be simply improved. The MPEG4, however, is not employed as the compression method when the content data is recorded onto the optical disc 100, such as a DVD. Thus, the conversion process is required for all the content data, aside from the recording operation. Moreover, the MPEG4-compressed content data cannot be encrypted by the encryption method which is used when the content data is recorded onto the optical disc 100 (e.g. CSC (Contents Scrambling System) method or the like), in terms of the standard of the MPEG4 compression method. Thus, when the content data is recorded onto the optical disc 100, the encryption process is required for all the content data, aside from the recording operation. The processes which are required aside from the recording operation lead to an increase in processing load on the information recording/reproducing apparatus 300, which is not preferable. According to the distribution system 1 in the embodiment, however, it is not necessary to perform these processes on the information recording/reproducing apparatus 300, and this leads to a reduction in processing load on the information recording/reproducing apparatus 300, which is a great advantage. Additionally, the confidentiality of the content data itself can be ensured.

Incidentally, the picture or pictures extracted as shown in FIG. 11 may be distributed. Here, FIG. 11 are data structure diagrams showing content data after predetermined pictures are extracted out of the MPEG2-compressed content data, and content data after predetermined pictures are extracted out of the MPEG4-compressed content data.

As shown in FIG. 11(a), only the I picture out of the MPEG2-compressed content data may be extracted and encrypted, selectively. At this time, the P picture and the B picture other than the I picture are extracted from the MPEG4-compressed and distributed content data in the step S205 in FIG. 10.

The data size of the MPEG2-compressed and distributed content data can be reduced by distributing the content data in this manner. This allows further improvement in the transmitting efficiency. Moreover, the confidentiality of the content data can be ensured because the content data cannot be reproduced if the I picture cannot be reproduced in the above manner.

Moreover, as shown in FIG. 11(b), not all the MPEG4-compressed content data needs to be distributed, but the distribution may be performed after only the B pictures are extracted. In other words, the MPEG2-compressed and encrypted I picture and P picture and the MPEG4-compressed B picture may be distributed from the content distributing server 200.

The confidentiality of the content data can be certainly ensured by distributing the content data in this manner even if the distributed content data in the network 400 is not encrypted in accordance with the above-mentioned standard of Triple DES, SSL, or the like. In view of considerable improvement in the confidentiality of the content data, the pictures other than at least the I picture out of the MPEG4-compressed content data may be distributed, as shown in FIG. 11(b), instead of the distribution of the MPEG4-compressed content data. In short, the encryption of the I picture ensures high confidentiality.

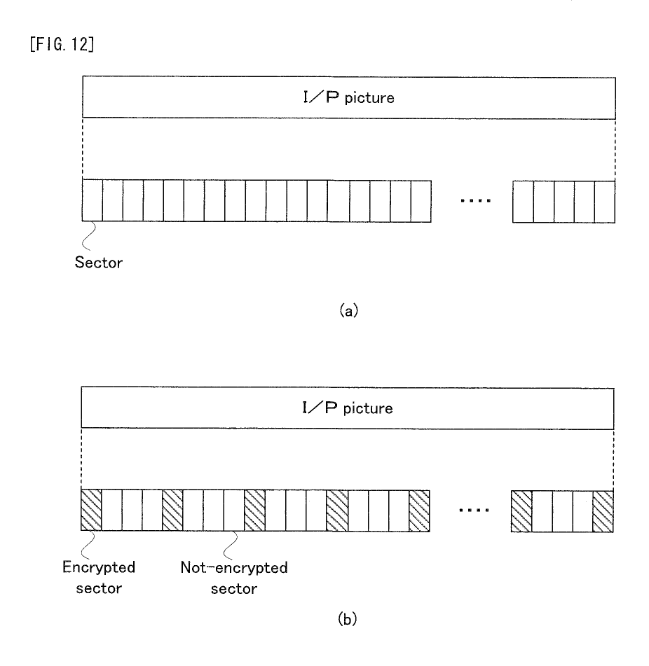

Moreover, when the I picture and the P picture are encrypted, it is not necessary to encrypt all the I picture and the P picture. As shown in FIG. 12, one portion thereof may be selectively encrypted. FIG. 12 are data structure diagrams conceptually showing an embodiment in which one portion of each of the I picture and the P picture is selectively encrypted.

As shown in FIG. 12(a), each of the I picture and the P picture has a data size of approximately 700 KB. On the other hand, one sector, which is a basic unit when the I picture and the P picture are encrypted, has a data size of 2 KB. Therefore, one picture is recorded over a plurality of sectors. In the above-mentioned embodiments, the encryption is performed by using the title key in each sector, and the title key is encrypted by the disk key in each sector (or in each sync frame). Incidentally, the sector, which is a basic unit when the I picture and the P picture are encrypted, corresponds to a sector which is a recording unit on the optical disc 100.

At this time, a data portion recorded in one portion of the plurality of sectors in which one picture is recorded may be encrypted and recorded, and a data portion recorded in another portion may be recorded without encryption. That is, as shown in FIG. 12(b), out of one I picture or P picture, a data portion recorded in an encrypted sector shown as a hatching portion may be encrypted and recorded, an a data portion recorded in a not-encrypted sector shown as a blank may be recorded without encryption.

The embodiments are explained by using the MPEG2 compression method and the MPEG4 compression method as the compression method; however, the present invention is not limited to this. For example, instead of the MPEG4 compression method, for example, a VC9 compression method may be employed, or another compression method may be employed. Moreover, the compression method when the content data is recorded onto the optical disc 100 does not have to be the MPEG2 compression method, and various compression methods may be employed. In short, the above-mentioned various benefits can be received by using the compression method which is used in recording the content data onto the optical disc 100 to compress and encrypt one data which can be reproduced solo out of the content data and by using the compression method which allows more highly efficient compression of another data (i.e. data which cannot be reproduced solo) other than the one data out of the content data. At this time, the one data is preferably encrypted and distributed by using the encryption method when the content data is recorded onto the optical disc 100.

Moreover, in the above-mentioned embodiments, the disc 100 is explained as one example of the information recording medium, and the recorder (player) related to the optical disc 100 is explained as one example of the receiving apparatus. The present invention, however, is not limited to the optical disc and the recorder (player) thereof, and it can be also applied to other various recording media and the recorder (player) thereof.

The present invention is not limited to the above-mentioned embodiments, and various changes may be made, if desired, without departing from the essence or spirit of the invention which can be read from the claims and the entire specification. A distributing apparatus and method, a receiving apparatus and method, a distribution system, and a computer program for reception control and for distribution control, which involve such changes, are also intended to be within the technical scope of the present invention.

### INDUSTRIAL APPLICABILITY

The distributing apparatus and method, the receiving apparatus and method, the distribution system, and the computer program of the present invention can be applied to a distributing apparatus for and method of distributing the content data, such as movies and music, a receiving apparatus for and method of receiving the content data to record or reproduce it, and a distribution system provided with the distributing apparatus and the receiving apparatus. Moreover, they can be applied to a distributing apparatus, a receiving apparatus, or the like, which is mounted on or can be connected to various computer equipment for consumer use or business use, for example.

1-16. (canceled)

17. A distributing apparatus comprising:
a first compressing device for compressing first data, which is a reproduction reference, out of predetermined content data in a first compression method;
a second compressing device for compressing at least second data other than the first data out of the content data in a second compression method with higher compression efficiency than that of the first compression method;
an encrypting device for encrypting at least one portion of the compressed first data; and
a distributing device for distributing each of the encrypted first data and the compressed second data to a receiving apparatus.

18. The distributing apparatus according to claim 17, wherein the first compression method is the same as a compression method which is used in recording the distributed content data onto a recording medium.

19. The distributing apparatus according to claim 17, wherein said encrypting device encrypts the compressed reference data in the same encryption method as an encryption method which is used in recording the distributed content data onto a recording medium.

20. The distributing apparatus according to claim 17, wherein
said second compressing device compresses all the content data, and
said distributing device distributes each of the encrypted first data and the compressed content data.

21. The distributing apparatus according to claim 17, wherein said encrypting device selectively encrypts one portion of the compressed first data.

22. The distributing apparatus according to claim 17, wherein
said encrypting device encrypts the compressed second data, and
said distributing device distributes the encrypted second data.

23. The distributing apparatus according to claim 17, wherein
the content data includes motion picture data,
the first compression method is MPEG2 and the second compression method is MPEG4,
the first data includes an image which is at least a reference out of the motion picture data, and
the second data includes an image other than the image which is the reference out of the motion picture data.

24. A distributing method comprising:
a first compressing process of compressing first data, which is a reproduction reference, out of predetermined content data in a first compression method;
a second compressing process of compressing at least second data other than the first data out of the content data in a second compression method with higher compression efficiency than that of the first compression method;
an encrypting process of encrypting at least one portion of the compressed first data; and
a distributing process of distributing each of the encrypted first data and the compressed second data to a receiving apparatus.

25. A receiving apparatus for receiving the content data distributed from a distributing apparatus comprising: a first compressing device for compressing first data, which is a reproduction reference, out of predetermined content data in a first compression method; a second compressing device for compressing at least second data other than the first data out of the content data in a second compression method with higher compression efficiency than that of the first compression method; an encrypting device for encrypting at least one portion of the compressed first data; and a distributing device for distributing each of the encrypted first data and the compressed second data to a receiving apparatus, said receiving apparatus comprising:
a receiving device for receiving each of the encrypted first data and the compressed second data, which are distributed;
a converting device for converting the compression method for the compressed second data from the second compression method to the first compression method; and
a generating device for generating the content data by combining the encrypted first data with the second data whose compression method is converted.

26. The receiving apparatus according to claim 25, further comprising a reproducing device for reproducing the generated content data.

27. The receiving apparatus according to claim 25, further comprising a recording device for recording the generated content data onto a recording medium.

28. The receiving apparatus according to claim 27, further comprising an imaging device for generating image file data in conformity to a recording format of the recording medium, on the basis of the generated content data,
said recording device recording the image file data onto the recording medium as the content data.

29. A receiving method of receiving the content data distributed from a distributing apparatus comprising: a first compressing device for compressing first data, which is a reproduction reference, out of predetermined content data in a first compression method; a second compressing device for compressing at least second data other than the first data out of the content data in a second compression method with higher compression efficiency than that of the first compression method; an encrypting device for encrypting at least one portion of the compressed first data; and a distributing device for distributing each of the encrypted first data and the compressed second data to a receiving apparatus, said receiving method comprising:
a receiving process of receiving each of the encrypted first data and the compressed second data, which are distributed;
a converting process of converting the compression method for the compressed second data from the second compression method to the first compression method; and
a generating process of generating the content data by combining the encrypted first data with the second data whose compression method is converted.

30. A distribution system comprising: a distributing apparatus for distributing predetermined content data; and at least one receiving apparatus for receiving the distributed content data,
said distributing apparatus comprising:
a first compressing device for compressing first data, which is a reproduction reference, out of predetermined content data in a first compression method;
a second compressing device for compressing at least second data other than the first data out of the content data in a second compression method with higher compression efficiency than that of the first compression method;
an encrypting device for encrypting at least one portion of the compressed first data; and
a distributing device for distributing each of the encrypted first data and the compressed second data to a receiving apparatus,
said receiving apparatus comprising:
a receiving device for receiving each of the encrypted first data and the compressed second data, which are distributed;
a converting device for converting the compression method for the compressed second data from the second compression method to the first compression method; and
a generating device for generating the content data by combining the encrypted first data with the second data whose compression method is converted.

31. A computer program product in a computer-readable medium for tangibly embodying a program of instructions executable by a computer provided in a distributing apparatus, to make the computer function as at least one portion of a first compressing device, a second compressing device, an encrypting device, and a distributing device,
said distributing apparatus comprising:
said first compressing device for compressing first data, which is a reproduction reference, out of predetermined content data in a first compression method;
said second compressing device for compressing at least second data other than the first data out of the content data in a second compression method with higher compression efficiency than that of the first compression method;
said encrypting device for encrypting at least one portion of the compressed first data; and
said distributing device for distributing each of the encrypted first data and the compressed second data to a receiving apparatus.

32. A computer program product in a computer-readable medium for tangibly embodying a program of instructions executable by a computer provided in a receiving apparatus, to make the computer function as at least one portion of a receiving device, a converting device, and a generating device,
said receiving apparatus for receiving the content data distributed from a distributing apparatus comprising: a first compressing device for compressing first data, which is a reproduction reference, out of predetermined content data in a first compression method; a second compressing device for compressing at least second data other than the first data out of the content data in a second compression method with higher compression efficiency than that of the first compression method; an encrypting device for encrypting at least one portion of the compressed first data; and a distributing device for distributing each of the encrypted first data and the compressed second data to a receiving apparatus, said receiving apparatus comprising:
said receiving device for receiving each of the encrypted first data and the compressed second data, which are distributed;
said converting device for converting the compression method for the compressed second data from the second compression method to the first compression method; and
said generating device for generating the content data by combining the encrypted first data with the second data whose compression method is converted.
